(19) United States
(12) Patent Application Publication
(10) Pub. No.: US 2013/0062311 A1
(43) Pub. Date: Mar. 14, 2013

(54) INDUCTIVELY COUPLED PLASMA PROCESSING APPARATUS AND METHOD FOR PROCESSING SUBSTRATE WITH THE SAME

(71) Applicant: Zhongdu LIU, Shanghai (CN)

(72) Inventor: Zhongdu LIU, Shanghai (CN)

(73) Assignee: ADVANCED MICRO-FABRICATION EQUIPMENT INC, SHANGHAI, Shanghai (CN)

(21) Appl. No.: 13/597,785

(22) Filed: Aug. 29, 2012

(30) Foreign Application Priority Data
Sep. 13, 2011 (CN) 201110269393.2

(51) Int. Cl. H05H 1/46; B05C 9/00; B44C 1/22

(52) U.S. Cl. 216/68; 156/345.48

(57) ABSTRACT

The invention relates to an inductively-coupled plasma processing apparatus and a method for processing a substrate. By arranging a magnetic field line adjusting component made of magnetic conductive material, a quasi-closed low reluctance path is formed to serve as the path of the magnetic field line loop outside of the reaction chamber, and the path of most magnetic field lines of the induced magnetic field is constrained by the low reluctance path. In this way, most of magnetic field energy diverged previously may be gathered, and then the magnetic field is multiplied; alternatively, less energy is required to obtain the same magnetic field strength to generate plasma for performing etching, which improves utilization efficiency of energy source.

This application claims the priority of Chinese Patent Application No. 201110269393.2, entitled “INDUCTIVELY COUPLED PLASMA PROCESSING APPARATUS AND METHOD FOR PROCESSING SUBSTRATE WITH THE SAME”, filed on Sep. 13, 2011 with State Intellectual Property Office of PRC, which is hereby incorporated by reference in its entirety.

### FIELD OF THE INVENTION

The invention relates to inductively-coupled plasma processing apparatus and method for processing substrate with the same, and more particularly to an inductively-coupled plasma processing apparatus capable of constraining path of magnetic field lines to gather divergent energy and a method for processing a substrate with the same.

### BACKGROUND OF THE INVENTION

At present, in manufacturing a semiconductor device, an inductively-coupled plasma processing apparatus is often adopted to generate plasma of reaction gas 50 for performing processes such as etching on a substrate 30.

As shown in FIG. 1, in an existing inductively-coupled plasma generator, reaction gas 50 is usually introduced into a vacuum reaction chamber 20. An induction coil 40 is usually arranged in the top (or the bottom or the sidewall) portion at the periphery of the reaction chamber 20 and a radio frequency source RF1 is applied to the inductor coil 40 to generate an induced magnetic field, and the induced magnetic field will induce radio frequency electric field in the axis direction of the coil, therefore the plasma of the reaction gas 50 is generated in the reaction chamber 20 to perform etching process on the substrate 30 fixed on an electro-static chuck 21 (ESC) at the bottom of the reaction chamber 20.

However, the distribution of magnetic field lines 410 of the induced magnetic field generated by the first radio frequency source RF1, which are shown as dashed lines in FIG. 1, is non-uniform above the substrate 30, leading to non-uniform distribution of plasma density in center portion and edge portion of the substrate 30, and thus affecting uniformity of etching at different positions on the substrate 30 in the radial direction.

In addition, since the induced magnetic field generated by the first radio frequency source RF1 is an open magnetic field, most of the energy is lost and only a small part of the energy in the portion above the substrate 30 is used to generate plasma. Therefore the utilization efficiency of energy resource is low. Moreover, most of the magnetic field energy that is not used may cause interference and the cost of eliminating the interference is very high. In addition, the magnetic field energy that is not used may induce heat, which will cause the rise of the temperature of the whole plasma generator, shorten service lifetime of the generator and reduce stability of etching operation.

### SUMMARY OF THE INVENTION

An object of the present invention is to provide an improved inductively-coupled plasma processing apparatus and a method for processing a substrate with the same. By arranging a magnetic field line adjusting component made of magnetic conductive material such as ferrite, a quasi-closed low reluctance structural arrangement of the magnetic field line adjusting component constitutes a part of a magnetic field line loop, so as to constrain the path of most magnetic field lines outside the reaction chamber. In this way, the magnetic field energy which is previously divergent may be gathered effectively, and the utilization efficiency of energy is improved. Furthermore, the strength of the induced magnetic field that is utilized to generate plasma may also be adjusted, so that the part of the magnetic field line loop above the substrate is in a uniform and linear distribution, thus improving the uniformity of the plasma distribution at the surface of the substrate.

In order to achieve the above object, the present invention provides an inductively-coupled plasma processing apparatus and a method for processing a substrate with the same.

The inductively-coupled plasma processing apparatus includes:

a reaction chamber into which reaction gas is introduced, where the reaction chamber includes a bottom base for fixing a substrate to be processed and a top portion of the reaction chamber opposite to the bottom base; and

an induction coil which is arranged at periphery of the reaction chamber and is connected to a first radio frequency source to generate an induced magnetic field.

The inductively-coupled plasma processing apparatus further includes:

a magnetic field line adjusting component, which is arranged at the periphery of the reaction chamber and is made of magnetic conductive material having a reluctance smaller than that of air or vacuum, where the magnetic field line adjusting component constitutes a quasi-closed low reluctance path at the periphery of the reaction chamber, so that magnetic field lines generated by the induction coil constitute a magnetic field line loop along the low reluctance path, with the magnetic field line loop passing through the reaction chamber.

The magnetic field line adjusting component is made of magnetic conductive material having a magnetic permeability that is 10 or more times of air magnetic permeability.

Preferably, the magnetic field line adjusting component is made of ferrite having a magnetic permeability that is 20-40 times of air magnetic permeability.

In a preferred embodiment, the magnetic field line adjusting component includes a top plate, a bottom plate and a side plate connected between the top plate and the bottom plate, the top plate, the bottom plate and the side plate being arranged at the periphery of the whole reaction chamber;

a first protrusion portion is arranged on the top plate, a second protrusion portion is arranged on the bottom plate, and the first protrusion portion and the second protrusion portion extend toward each other respectively from the top plate and the bottom plate.

In another preferred embodiment, the magnetic field line adjusting component has a C-shaped overall structure, i.e. the magnetic field line adjusting component includes a top plate, a bottom late and a side plate which are arranged in connection at the periphery of the reaction chamber;

One end of the top plate is connected to the upper end of the side plate, and the other end of the top plate is arranged with a first protrusion portion which extends to a position above the induction coil; one end of the bottom plate is connected to the lower end of the side plate, and the other end of the bottom plate is arranged with a second protrusion portion which extends to a position the bottom base.

The induction coil is wound around the magnetic field line adjusting component.

The inductively-coupled plasma processing apparatus further includes a first adjusting coil, where any part of the low reluctance path on the magnetic field line adjusting component passes through the first adjusting coil.

The first adjusting coil is connected to a third radio frequency source; by changing the power or frequency of the third radio frequency source, a first additional magnetic field is obtained in the magnetic field line adjusting component and is superposed on the induced magnetic field obtained by applying the first radio frequency source, so as to adjust the magnetic field strength of the induced magnetic field.

The inductively-coupled plasma processing apparatus further includes a measurement coil, where any part of the low reluctance path on the magnetic field line adjusting component passes through the measurement coil, so as to detect the magnetic field strength.

The inductively-coupled plasma processing apparatus further includes a shielding ring made of metallic conductor, where the shielding ring is in a closed loop structure which is arranged in the reaction chamber and surrounds an out edge of the substrate, and when the induced magnetic field generated by applying the first radio frequency source passes through the closed shielding ring, a reverse regenerated magnetic field is induced and is superposed on the induced magnetic field to adjust the magnetic field strength of the induced magnetic field.

In an embodiment, the shielding ring is in a closed loop structure surrounding the edges of the first protrusion portion and the second protrusion portion of the magnetic field line adjusting component, the shielding ring extends from the first protrusion portion to the second protrusion portion in the longitudinal direction and is in tight connection with the first protrusion portion and the second protrusion portion in a sealed form, so that the shielding ring becomes a new sidewall of the reaction chamber.

A second adjusting coil is wound around the shielding ring, and the second adjusting coil is applied with a fourth radio frequency source; by changing the power or frequency of the fourth radio frequency source, a second additional magnetic field is induced in the axial direction of the shielding ring, and the second additional magnetic field is superposed on the induced magnetic field to adjust magnetic field strength, shape and distribution of magnetic field lines at the edge portion of the substrate.

A plurality of supply passages are arranged to pass through the magnetic field line adjusting component. The supply passages include an electric passage through which the first radio frequency source is applied to the induction coil and an inlet passage through which the reaction gas is introduced into the reaction chamber.

The method for processing a substrate includes:

arranging, in an inductively-coupled plasma processing apparatus, a reaction chamber into which reaction gas is introduced, where the reaction chamber includes a bottom base for fixing a substrate to be processed; and

arranging an induction coil at the periphery of the reaction chamber, where the induction coil is connected to a first radio frequency source to generate an induced electromagnetic field for producing the plasma of the reaction gas in the reaction chamber to process the substrate.

The method for processing a substrate further includes:

arranging a magnetic field line adjusting component made of magnetic conductive material at the periphery of the reaction chamber, where the magnetic field line adjusting component has a reluctance smaller than that of air or vacuum, and constitutes a quasi-closed low reluctance path at the periphery of the reaction chamber, so that the magnetic field lines generated by the induction coil constitute a magnetic field line loop along the low reluctance path; and

adjusting reluctance distribution on the low reluctance path to adjust the shape and distribution of the magnetic field lines in the magnetic field line loop that locate in the reaction chamber, and thus control the distribution of the plasma generated at the surface of the substrate under the action of the magnetic field lines.

The magnetic field line adjusting component is made of magnetic conductive material having a magnetic permeability that is 10 or more times that of air magnetic permeability. Preferably, the magnetic field line adjusting component is made of ferrite having a magnetic permeability that is 20-40 times that of air magnetic permeability.

The magnetic field line adjusting component includes a movable magnetic conductive component to adjust a shape and distribution of the magnetic field lines flowing through the magnetic field line adjusting component (10) or a magnetic field strength in the magnetic field line adjusting component (10) by adjusting position of the movable magnetic conductive component.

The induction coil is arranged in a top portion or a bottom portion or on a sidewall of the reaction chamber; alternatively, the induction coil is arranged on the magnetic field line adjusting component such that any part of the low reluctance path on the magnetic field line adjusting component passes through the induction coil; and

The magnetic field strength in the magnetic field line adjusting component is controlled by the frequency or power of the first radio frequency source applied to the induction coil.

The method for processing a substrate further includes: arranging a first adjusting coil such that any part of the low reluctance path on the magnetic field line adjusting component passes through the first induction coil; and

applying a third radio frequency source to the first adjusting coil, where by changing the power or frequency of the third radio frequency source, a first additional magnetic field is obtained in the magnetic field line adjusting component and is superposed on the induced magnetic field obtained by applying the first radio frequency source, thereby adjusting the magnetic field strength of the induced magnetic field.

A shielding ring made of metallic conductor is arranged in the reaction chamber (20) to surround an out edge of the substrate, a second adjusting coil is selectively arranged on the shielding ring and a fourth radio frequency source is applied, where by changing the frequency or power of the fourth radio frequency source, a second additional magnetic field is induced in the axial direction of the shielding ring and is superposed on the induced magnetic field to adjust the magnetic field strength and shape and distribution of the magnetic field lines at the edge portion of the substrate.

The inductively-coupled plasma processing apparatus includes:

a magnetic field line adjusting component made of magnetic conductive material;

a plasma processing space, in which a reaction gas supply means and a substrate mounting platform are provided;

where the magnetic field line adjusting component and the plasma processing space constitute a magnetic field line loop collectively, and

an induction coil connected to a radio frequency power supply, where the magnetic field lines generated by the induction coil pass through the plasma processing space along the magnetic field line loop.

The magnetic conductive material is ferrite material and more than 80% of the magnetic flux generated by the coil flows through the magnetic field line loop.

The inductively-coupled plasma processing apparatus includes:

a magnetic field line adjusting component made of magnetic conductive material, where the magnetic field line adjusting component includes at least one quasi-closed loop with an open space, and a reaction chamber is provided in the open space;

a reaction gas supply means and a substrate mounting platform in the reaction chamber; and an induction coil connected to a radio frequency power supply, where the magnetic field lines generated by the induction coil pass through the reaction chamber in the open space along the quasi-closed loop constituted by the magnetic field line adjusting component.

The magnetic field line adjusting component includes a protrusion component, the protrusion component is located under the substrate mounting platform and has a cross-section corresponding to the shape of the substrate to be processed.

Compared to the prior art, the inductively-coupled plasma processing apparatus and the method for processing a substrate according to the present invention have advantages as follows:

In the present invention, by arranging a magnetic field line adjusting component made of magnetic conductive material having a magnetic permeability that is 10 or more times of air magnetic permeability, the low reluctance structural arrangement of magnetic field line adjusting component constitutes a flow path of the magnetic field line loop outside of the reaction chamber, i.e. a quasi-closed low reluctance path is formed to constrain the path of most of the magnetic field lines of the induced magnetic field, thereby gathering most of the magnetic field energy which is divergent previously. Therefore, compared with the existing plasma processing device, only 1/10 of energy supply is required to obtain the same magnetic field strength for generating the plasma useful in etching, which improves utilization efficiency of energy source; or, the magnetic field may be multiplied under the same power consumption. Furthermore, this may also greatly reduce the RF electromagnetic leakage, electromagnetic interference on environment and the heating of the device, and thus improve reliability and stability of system. Preferably, the magnetic field line adjusting component is made of ferrite and the magnetic field strength may be improved by 20-40 times. Cooling means such as water cooling means may be arranged in the magnetic field line adjusting component to perform cooling process on the heat induced after gathering energy.

On the other hand, the low reluctance structure of the magnetic field line adjusting component also determines the distribution of the magnetic field lines in the reaction chamber which are used to generate the plasma. For example, a first protrusion portion and a second protrusion portion which extends towards each other may be arranged on the magnetic field line adjusting component and be made to correspond to the positions of two magnetic poles respectively, preferably rendering the magnetic field lines between the two protrusion portions in a uniform distribution, so as to improve the distribution uniformity of the plasma at the surface of the substrate. Further, a first adjusting coil may be arranged on the low reluctance path to generate a first additional magnetic field by applying a radio frequency source, and the first additional magnetic field is superposed on the original induced magnetic field to adjust the magnetic field strength. Furthermore, a shielding ring may also be wound from the edge of the first protrusion portion to the edge of the second protrusion portion, or a second adjusting coil is further wound around the shielding ring and is applied with a radio frequency source, so as to adjust the distribution of the magnetic field lines, including the direction, shape and density of the magnetic field lines, at the edge portion of the substrate.

### BRIEF DESCRIPTION OF THE DRAWINGS

FIG. 1 is a schematic diagram of an overall structure of an inductively-coupled plasma processing apparatus in the prior art;

FIG. 2 is a schematic structural diagram of a closed-transformer type magnetic field line adjusting component in embodiment 1 of the present invention;

FIG. 3 is a schematic structural diagram of a closed-barrel type magnetic field line adjusting component in the embodiment 1 of the present invention;

FIG. 4 is a longitudinal cross-sectional diagram of the inductively-coupled plasma processing apparatus using the closed-transformer type or closed-barrel type magnetic field line adjusting component in the embodiment 1 of the present invention;

FIG. 5 and FIG. 6 are longitudinal cross-sectional diagrams of the inductively-coupled plasma processing apparatus using the closed-transformer type or closed-barrel type magnetic field line adjusting component in the embodiment 2 of the present invention;

FIG. 7 and FIG. 8 are longitudinal cross-sectional diagrams of the inductively-coupled plasma processing apparatus using the closed-transformer type or closed-barrel type magnetic field line adjusting component in the embodiment 3 of the present invention;

FIG. 9 is a longitudinal cross-sectional diagram of the inductively-coupled plasma processing apparatus using a quasi-closed type magnetic field line adjusting component in the embodiment 1 and embodiment 2 of the present invention;

FIG. 10 is a longitudinal cross-sectional diagram of the inductively-coupled plasma processing apparatus using a quasi-closed type magnetic field line adjusting component in the embodiment 3 of the present invention;

FIG. 11 is a longitudinal cross-sectional diagram of the inductively-coupled plasma processing apparatus using the closed-transformer type or closed-barrel type magnetic field line adjusting component in the embodiment 4 of the present invention; and

FIG. 12 is a longitudinal cross-sectional diagram of the inductively-coupled plasma processing apparatus using the quasi-closed type magnetic field line adjusting component in the embodiment 4 of the present invention.

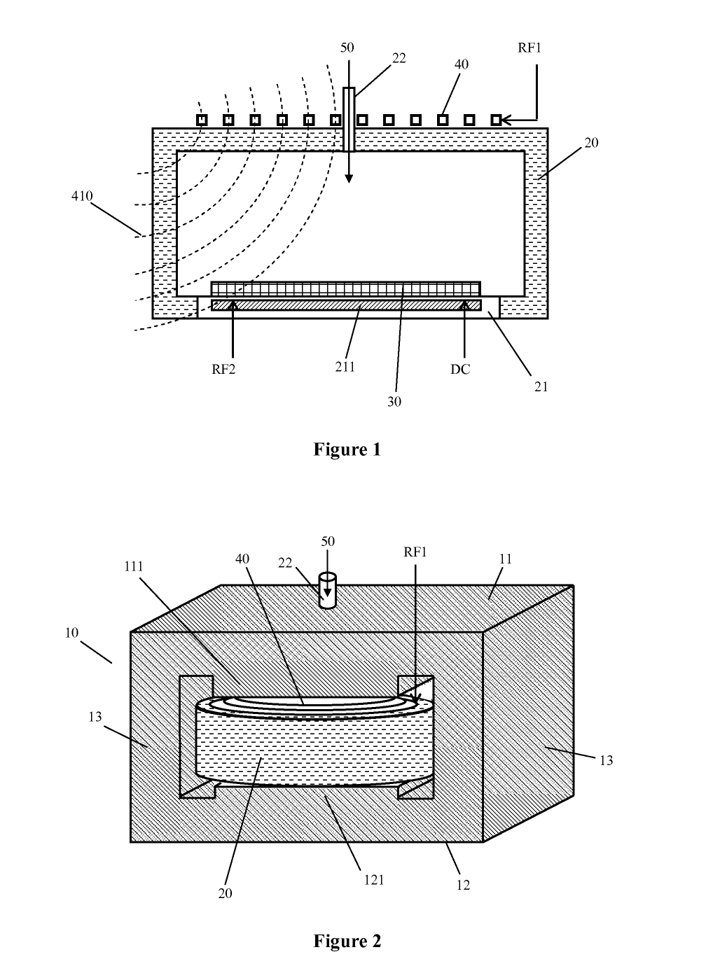

### DETAILED DESCRIPTION OF THE INVENTION

Several embodiments of the present invention will be described in conjunction with drawings hereinafter.

### Embodiment 1

As shown in FIGS. 2, 3 and 4, the inductively-coupled plasma processing apparatus according to the present invention includes a vacuum reaction chamber 20 into which reaction gas 50 is introduced. An induction coil 40 is arranged on top of the periphery of the reaction chamber 20, and is connected to a first radio frequency source RF1 to generate an induced magnetic field and to induce a radio frequency electric field in the axial direction of the induction coil, so as to generate the plasma of the reaction gas 50 in the reaction chamber 20. An electro-static chuck (ESC) 21 and a base are arranged at the bottom of the reaction chamber 20 to fix a substrate 30.

As an improvement to the inductively-coupled plasma processing apparatus , the inductively-coupled plasma processing apparatus in the present invention further includes a magnetic field line adjusting component 10 made of magnetic conductive material having a magnetic permeability that is 10 or more times of air magnetic permeability; since the reluctance of the magnetic field line adjusting component 10 is less than the reluctance of air or vacuum, the magnetic field line adjusting component 10 constitutes the path of the magnetic field lines of the induced magnetic field outside the reaction chamber after being applied with the first radio frequency source RF1. Other magnetic field lines inside the reaction chamber is used to generate plasma above the substrate 30; the magnetic field lines outside the reaction chamber is closed to form a complete low reluctance path 41 (indicated by dashed lines in the figures, where only the left half of the magnetic field line loop is shown and the symmetric right half of the magnetic field line loop is not shown).

Preferably, the magnetic field line adjusting component 10 may be made of ferrite, the magnetic permeability of which is 20-50 times of air magnetic permeability. Therefore, most of magnetic field lines flow through the magnetic field line adjusting component 10, and the path distribution of these magnetic field lines may be adjusted by the low reluctance structural arrangement of the magnetic field line adjusting component 10 to regulate direction, shape and density of the magnetic field lines.

As shown in FIG. 2, in a preferred embodiment, the overall structure of the magnetic field line adjusting component 10 is similar to a three-phase three-leg transformer (referred to as “transformer type” hereinafter), i.e., the magnetic field line adjusting component 10 includes: a top plate 11, a bottom plate 12 and two opposite side plates 13 arranged at the periphery of the whole reaction chamber 20. A first protrusion portion 111 is arranged on the central part of the top plate 11, and the first protrusion portion 111 extends downwardly to a position above the induction coil 40; accordingly, a second protrusion portion 121 is arranged on the central part of the bottom plate 12, and the second protrusion portion 121 extends upwardly to a position under the electro-static chuck 21.

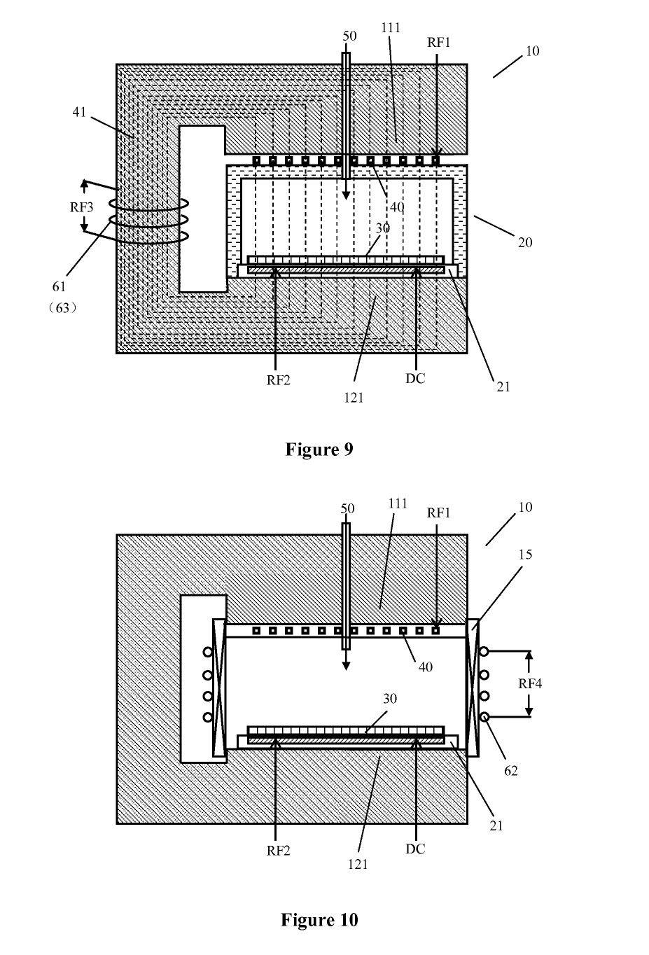

As shown in FIG. 9, in another preferred embodiment, the magnetic field line adjusting component 10 may be of a quasi-closed type and in a C-shaped overall structure, i.e., the magnetic field line adjusting component 10 is only provided with one side plate 13; one end of the top plate 11 is connected to the upper end of the side plate 13, and the other end of the top plate 11 extends to the first protrusion portion 111 above the induction coil 40; one end of the bottom plate 12 is connected to the lower end of the side plate 13, and the other end of the bottom plate 12 extends to the second protrusion portion 121 under the electro-static chuck 21.

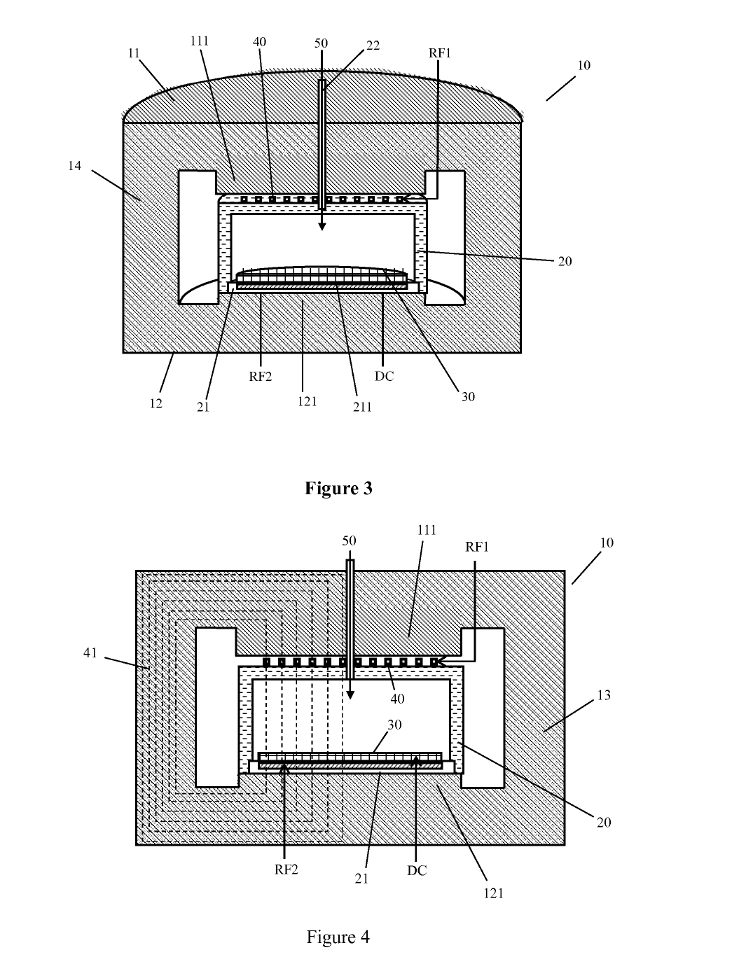

As shown in FIG. 3, which shows still another preferred embodiment, the magnetic field line adjusting component 10 is in a barrel structure, i.e., the magnetic field line adjusting component 10 includes a top plate 11, a bottom plate 12 and an annular sidewall 14 which is arranged to surround the periphery of the whole reaction chamber 20, where a first protrusion portion 111 is arranged at the central part of the top plate 11 and the first protrusion portion 111 extends downwardly to a position above the induction coil 40; and a second protrusion portion 121 is arranged at the central part of the bottom plate 12 and the second protrusion portion 121 extends upwardly to a position under the electro-static chuck 21.

Referring to FIGS. 2, 3 and 9, in the magnetic field line adjusting component 10 of the transformer type or the quasi-closed type or the barrel type, the structure of the first protrusion portion 111 and the second protrusion portion 121 determines the distribution of magnetic field lines between the first protrusion portion 111 and the second protrusion portion 121, and also determines the distribution of the magnetic field lines in the low reluctance path 41 that are used in the reaction chamber 20 to produce plasma. Preferably, by adjusting the structure, the magnetic field lines between the first protrusion portion 111 and the second protrusion portion 121 may be distributed uniformly in the vertical direction so as to form a linear field on the surface of the substrate 30, which improves the uniformity of the plasma generated accordingly at the center and edge portions of the substrate 30, so that the etching at different positions on the substrate 30 in the radial direction achieves the same effect.

Several supply passages are arranged to pass through the upper potion of the magnetic field line adjusting component 10. For example, an electric passage is arranged on the top plate 11 to introduce the first radio frequency source RF1 to the induction coil 40; and an inlet passage 22 is arranged in the first protrusion part 111 of the top plate 11 to introduce the reaction gas 50 into the reaction chamber 20. Similarly, several supply passages are also arranged in the lower part of the magnetic field line adjusting component 10. For example, several supply passages may be arranged to pass through the second protrusion 121 of the bottom plate 12; the supply passage may be an electric passage which connects the second radio frequency source RF2 (of a frequency of about 2 MHz) for adjusting incident energy of plasma or a direct current supply DC connecting to a lower electrode 211 in the electro-static chuck 21, a coolant passage (not shown) for conveying cooling gas or cooling liquid to the electro-static chuck 21, or a discharge passage (not shown) for discharging the reaction gas 50, etc. Although the space in the magnetic field line adjusting component formed by these supply passages will affect the overall reluctance distribution, it will not prevent most of magnetic field lines passing through the surface of the substrate 30 uniformly since the volume of the space is much less than the volume of the whole ferrite component such as the volume of the first protrusion portion 111 or the second protrusion portion 121.

### Embodiment 2

Referring to FIGS. 5, 6 and 9, the overall structure of the inductively-coupled plasma processing apparatus according to the embodiment is similar with that in the embodiment 1 and includes: a transformer type or quasi-closed type or barrel type magnetic field line adjusting component 10 which is arranged at the periphery of the reaction chamber 20, where the magnetic field line adjusting component 10 is made from magnetic conductive material of low reluctance; most of magnetic field lines of the induced magnetic field generated by an induction coil 40 arranged outside of the top of the reaction chamber 20 after being applied with a first radio frequency source RF 1 flow through the magnetic field line adjusting component 10, and the distribution of the magnetic field lines outside and inside the reaction chamber 20 is determined by the structure of the magnetic field line adjusting component 10. Preferably, in the reaction chamber 20, the magnetic field lines above the substrate 30 are rendered to be distributed linearly and uniformly, in order to improve the distribution uniformity of the plasma at central and edge portions on the surface of the substrate 30.

The improvement on the structure in the embodiment is that a first adjusting coil 61 is provided, such that any part of the corresponding low reluctance path 41 on the magnetic field line adjusting component 10 passes through the first adjusting coil 61 and the first adjusting coil 61 is connected to a third radio frequency source RF3. For example, the first adjusting coil 61 is arranged on the side plate 13 of the magnetic field line adjusting component 10 (as shown in FIG. 5 or FIG. 9), and by changing the power or frequency of the third radio frequency source RF3, a first additional magnetic field is obtained in the magnetic field line adjusting component 10 and is superposed on the induced magnetic field obtained by applying the first radio frequency source RF1, thus adjusting the magnetic field strength of the induced magnetic field.

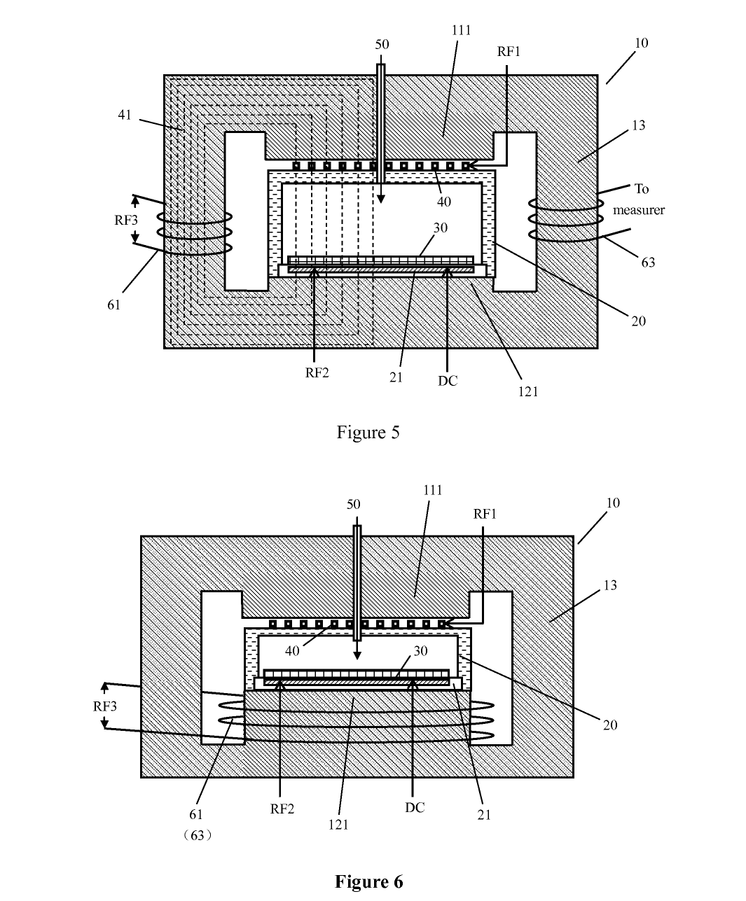

In addition, similar to the arrangement of the first adjusting coil 61, a measurement coil 63 may also provided such that any part of the corresponding low reluctance path 41 on the magnetic field line adjusting component 10 passes through the measurement coil 63, so as to detect the magnetic field strength. For example, the measurement coil 63 may be arranged on the side plate 13 of the magnetic field line adjusting component 10; or, the measurement coil 63 may be wound around the first protrusion portion 111 (this case is not shown) or the second protrusion portion 121 (shown in FIG. 6).

According to the specific requirements of applications, the measurement coil 63 and the first adjusting coil 61 may be arranged at different positions of the magnetic path of the magnetic field line adjusting component 10 together. For example, they may be arranged on a respective one of the two side plate 13 of the transformer type magnetic field line adjusting component 10 (shown in FIG. 5). Alternatively, it is possible to arrange only one of the measurement coil 63 and the first adjusting coil 61 on the magnetic field line adjusting component 10.

### Embodiment 3

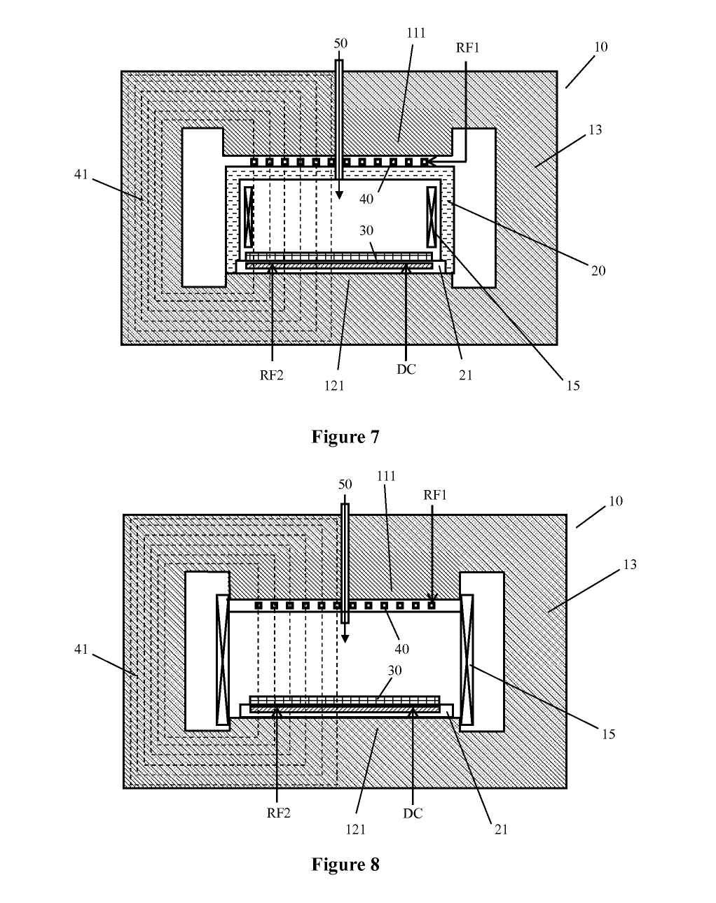

Referring to FIGS. 7, 8 and 10, the overall structure of the inductively-coupled plasma processing apparatus according to the embodiment is similar to that in the embodiment 1 and embodiment 2, which includes a magnetic field line adjusting component 10 of the transformer type or the quasi-closed type or the barrel type arranged at the periphery of the reaction chamber 20, where the magnetic field line adjusting component 10 is made of magnetic conductive material of low reluctance such as ferrite; most of magnetic field lines of the induced magnetic field generated by an induction coil 40 arranged outside of the top of the reaction chamber 20 after being applied with a first radio frequency source RF1 flow through the magnetic field line adjusting component 10, and the distribution of the magnetic field lines outside and inside the reaction chamber 20 is determined by the structure of the magnetic field line adjusting component 10. Preferably, in the reaction chamber 20, the magnetic field lines above the substrate 30 are rendered to be distributed uniformly and linearly, in order to improve the distribution uniformity of the plasma at central and edge portions on the surface of the substrate 30.

On the basis of the embodiment 1 and embodiment 2, a shielding ring 15 made of metallic conductor is further provided in the embodiment. The shielding ring 15 may be in a closed loop structure which is arranged in the reaction chamber 20 and surrounds an out edge of the substrate 30. The height and the vertical position of the shielding ring 15 may be set arbitrarily, and the function of the shielding ring 15 is to adjust the distribution of the electric field. The high-frequency alternating magnetic field generated by applying the first radio frequency source RF1, which vertically passes through the reaction region downwardly, will induce an alternating electric field in a direction perpendicular/orthogonal to the direction of the magnetic field. Due to the existence of the shielding ring 15, a part of the induced electric field may generate current in the shielding ring, which in turn induces secondary magnetic field in a direction opposite to the direction of the original magnetic field. Therefore, the magnitude and distribution of the secondary electric field may be adjusted by adjusting the size and impedance of the shielding ring, thereby further tuning the magnetic field distribution on the basis of the original magnetic field distribution and achieving a better plasma processing uniformity.

If the shielding ring 15 has an enough height, for example, the shielding ring 15 is capable of extending from the top of the reaction chamber 20 to a position above the substrate 30 (shown in FIG. 7), the shielding ring 15 may also function to shield the plasma. Alternatively, the shielding ring 15 may also be in a closed loop structure that surrounds the edges of the first protrusion portion 111 and the second protrusion portion 121 of the magnetic field line adjusting component 10, where the shielding ring 15 extends from the first protrusion portion 111 to the second protrusion portion 121 in the longitudinal direction and is in a close connection with the first protrusion portion 111 and the second protrusion portion 121, so that the shielding ring 15 forms a new sidewall (shown in FIG. 8, FIG. 10) of the reaction chamber.

Furthermore, a second adjusting coil 62 may be wound around the shielding ring 15 (shown in FIG. 10), and the second adjusting coil 62 is applied with a fourth radio frequency source RF4. By changing the power or frequency of the fourth radio frequency source RF4, a second additional magnetic field is induced in the axial direction of the shielding ring 15, and the second additional magnetic field is superposed on the induced magnetic field obtained by applying the first radio frequency source RF1, so as to adjust the magnetic field strength and the distribution of magnetic field lines in the reaction region, especially to adjust the magnetic field strength and the distribution of magnetic field lines at the edge portion of the substrate 30.

### Embodiment 4

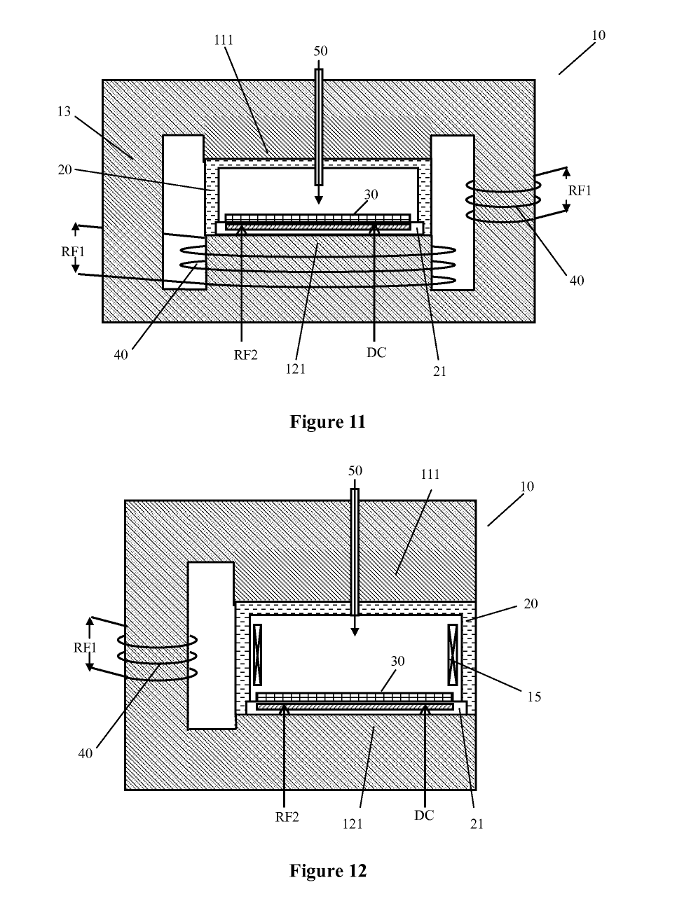

Referring to FIGS. 11 and 12, in the inductively-coupled plasma processing apparatus according to the embodiment, the overall structure of the magnetic field line adjusting component 10 is similar to that in the embodiment 1, which may be a transformer type or quasi-closed type or barrel type structure that is arranged at the periphery of the reaction chamber 20, and is made of magnetic conductive material with low reluctance, such as ferrite.

In the embodiment, the induction coil 40 is arranged directly on the magnetic field line adjusting component 10, which is different from the above embodiments in which the induction coil 40 is arranged outside of the top of the reaction chamber 20. Specifically, in the embodiment, the position for arranging the induction coil 40 is similar to that of the adjusting coil 61 or the measurement coil 63 in the embodiment 2, i.e., any part of the corresponding low reluctance path 41 on the magnetic field line adjusting component 10 passes through the induction coil 40, and the magnetic field lines of the induced magnetic field generated by applying the first radio frequency source RF1 will directly pass through the magnetic field line adjusting component 10. Therefore, the magnetic field strength in the magnetic field line adjusting component 10 may be controlled directly by the frequency or power of the first radio frequency source RF1, i.e., the strength of the magnetic field between the first protrusion portion 111 and the second protrusion portion 121 which is used to form the plasma may be directly controlled.

For example, the induction coil 40 may be arranged on the side plate 13 of the magnetic field line adjusting component 10, or the induction coil 40 may be arranged on the first protrusion portion 111 (this case is not shown) or the second protrusion portion 121 of the magnetic field line adjusting component 10.

The measurement coil 63 in the embodiment 2 which is used in energy detection may be arranged to be in coexistence with the induction coil 40 but at a different position on the low reluctance path 41. When arranging the induction coil 40, a shielding ring 15 in the embodiment 3 may also be arranged to surround from the edge of the first protrusion portion 111 to the edge of the second protrusion portion 121 of the magnetic field line adjusting component 10; or the shielding ring 15 is in close connection with the first protrusion portion 111 and the second protrusion portion 121 to form a new sidewall of the reaction chamber.

To conclude, the inductively-coupled plasma processing apparatus according to the present invention is provided with a magnetic field line adjusting component 10 made of magnetic conductive material having a magnetic permeability that is 10 or more times of air magnetic permeability. Preferably, the magnetic field line adjusting component 10 is made of ferrite, so that the magnetic field strength may be improved by 20-40 times. The magnetic field line adjusting component 10 constitutes a quasi-closed low reluctance path 41 to sever as the path of the magnetic field line loop outside of the reaction chamber 20, so as to constrain the path of most magnetic field lines of the magnetic field, and thus gathering most of magnetic field energy that is divergent previously.

The term “quasi-closed” means that, although there exists an open space to accommodate the reaction chamber 20 and the plasma generation space inside the reaction chamber 20, the size and the shape of the open space is not very large as compared with the overall low reluctance path 41. Therefore, most of magnetic flux that flows through the ferrite component in the low reluctance path is not diverged to out space to turn into an interference source in the whole plasma processor and constitutes a complete magnetic field line loop along the low reluctance path defined by the magnetic field line adjusting component and the open space. As a result, the distribution of the magnetic field lines approximates to the case in which a closed ferrite ring is arranged. The low reluctance path in the present invention has a structure of quasi-closed ferrite loop, so that only less than 20% of the magnetic flux that flows through the ferrite component on the low reluctance path, is diverged outside of the low reluctance path. Therefore, compared with the existing plasma processing device, only 1/10 of energy supply is required to obtain the same magnetic field strength to generate the plasma for performing etching, which improves utilization efficiency of energy source; or, the magnetic field may be multiplied under the same power consumption. Furthermore, the RF electromagnetic leakage, electromagnetic interference on environment and the heating of the device may be reduced greatly and thus the reliability and stability of system are improved. A cooling means such as a water cooling means may be arranged in the magnetic field line adjusting component 10 to perform cooling process on the heat induced after gathering energy.

In another aspect, the low reluctance structure of the magnetic field line adjusting component 10 also determines the distribution of the magnetic field lines in the reaction chamber 20 which are used to generate plasma. A first protrusion portion and a second protrusion portion may be arranged on the magnetic field line adjusting component and be made to correspond to the positions of two magnetic poles respectively, preferably rendering the magnetic field lines between the two protrusion portions in a uniform distribution, so as to improve the distribution uniformity of the plasma on the surface of the substrate. A first adjusting coil 61 may be arranged at any position on the low reluctance path 41 to generate a first additional magnetic field by applying a radio frequency on the first adjusting coil 61, and the first additional magnetic field is superposed on the original induced magnetic field to adjust the magnetic field strength. Furthermore, a shielding ring 15 may be wound from the edge of the first protrusion portion 111 to the edge of the second protrusion portion 121, and a second adjusting coil 62 is further wound around the shielding ring 15 and is applied with a radio frequency source, so as to adjust the distribution of the magnetic field lines, including the direction, shape and density of the magnetic field lines, at the edge portion of the substrate 30.

Based on the arrangement of the inductively-coupled plasma processing apparatus and the magnetic field line adjusting component therein, the present invention further provides a method for processing a substrate, in which by arranging a magnetic field line adjusting component made of magnetic conductive material, the flow path of the magnetic field line loop of the induction coil after being applied with a first radio frequency source RF1 is determined by the low reluctance structural arrangement of the magnetic field line adjusting component; and for different process requirements, by adjusting distribution of the magnetic field lines or magnetic field strength in the reaction chamber, the distribution of the plasma on the surface of the substrate may be controlled.

Specifically, the magnetic field line adjusting component with different structure may be used, such as a transformer type, a barrel type or a quasi-closed type magnetic field line adjusting component.

A first adjusting coil may be arranged at any position in corresponding quasi-closed low reluctance path on the magnetic field line adjusting component, or the position for arranging the induction coil may be changed, or a second adjusting coil may be arranged on the shielding ring, or the applied power or frequency of the radio frequency source may be changed to achieve the adjustment on the magnetic field strength, thus controlling the density of the plasma on the surface of the substrate.

Alternatively, at least one part of the magnetic field line adjusting component is set as a movable or adjustable structure. For example, the first or second protrusion portion is set as a structure capable of being removed from the top plate or the bottom plate; for different process requirements or for requirements on etching at different positions of the substrate, the first protrusion portion or the second protrusion portion may be in different shapes to control the distribution of the magnetic field lines on the surface of the substrate. For example, a shielding ring with different shapes and structures may be used or the height for arranging the shielding ring between the first protrusion portion and the second protrusion portion may be adjusted, to accordingly adjust the distribution of the magnetic field lines at the edge portion of substrate. Preferably, the magnetic field lines corresponding to the center and edge portion of the substrate are distributed uniformly, thus improving the distribution uniformity of the plasma on the surface of the substrate so that the effect of processing done on different positions of the substrate is constant.

Although the present invention has been described in details through the above preferred embodiments, it should be realized that the above description should not be considered as limit to the present invention. Various modifications and alternatives of the present invention will be obvious to those skilled in the art in view of the above contents. Therefore the scope of protection of the present invention should be defined by the following claims.

1. An inductively-coupled plasma processing apparatus, comprising:
a reaction chamber into which reaction gas is introduced, wherein the reaction chamber comprising a bottom base for fixing a substrate to be processed and a top portion of the reaction chamber opposite to the bottom base;
an induction coil, which is arranged at periphery of the reaction chamber and is connected to a first radio frequency source to generate an induced magnetic field;
a magnetic field line adjusting component, which is arranged at the periphery of the reaction chamber and is made of magnetic conductive material having a reluctance smaller than that of air or vacuum, wherein the magnetic field line adjusting component constitutes a quasi-closed low reluctance path at the periphery of the reaction chamber, so that magnetic field lines generated by the induction coil constitute a magnetic field line loop along the low reluctance path, with the magnetic field line loop passing through the reaction chamber.

2. The inductively-coupled plasma processing apparatus according to claim 1, wherein the magnetic field line adjusting component is made of magnetic conductive material having a magnetic permeability that is 10 or more times of air magnetic permeability.

3. The inductively-coupled plasma processing apparatus according to claim 2, wherein the magnetic field line adjusting component is made of ferrite having a magnetic permeability that is 20-40 times of air magnetic permeability.

4. The inductively-coupled plasma processing apparatus according to claim 3, wherein:
the magnetic field line adjusting component comprises a top plate, a bottom plate and a side plate connected between the top plate and the bottom plate, the top plate, the bottom plate and the side plate being arranged at the periphery of the whole reaction chamber;
a first protrusion portion is arranged on the top plate, a second protrusion portion is arranged on the bottom plate, the first protrusion portion and the second protrusion portion extend toward each other respectively from the top plate and the bottom plate.

5. The inductively-coupled plasma processing apparatus according to claim 3, wherein:
the magnetic field line adjusting component has a C-shaped overall structure, which means the magnetic field line adjusting component comprises a top plate, a bottom late and a side plate which are arranged in connection at the periphery of the reaction chamber;
one end of the top plate is connected to an upper end of the side plate, and the other end of the top plate is arranged with a first protrusion portion which extends to a position above the induction coil; one end of the bottom plate is connected to a lower end of the side plate, and the other end of the bottom plate is arranged with a second protrusion portion which extends to a position under the bottom base.

6. The inductively-coupled plasma processing apparatus according to claim 1, wherein the induction coil is wound around the magnetic field line adjusting component.

7. The inductively-coupled plasma processing apparatus according to claim 1, further comprising a first adjusting coil, wherein any part of the low reluctance path on the magnetic field line adjusting component passes through the first adjusting coil, the first adjusting coil is connected to a third radio frequency source, by changing a power or frequency of the third radio frequency source, a first additional magnetic field is obtained in the magnetic field line adjusting component, and the first additional magnetic field is superposed on the induced magnetic field obtained by applying the first radio frequency source, so as to adjust the magnetic field strength of the induced magnetic field.

8. The inductively-coupled plasma processing apparatus according to claim 1, further comprising a measurement coil, wherein any part of the low reluctance path on the magnetic field line adjusting component passes through the measurement coil, so as to detect the magnetic field strength.

9. The inductively-coupled plasma processing apparatus according to claim 1, further comprising a shielding ring made of metallic conductor, wherein the shielding ring is in a closed loop structure which is arranged in the reaction chamber and surrounds an out edge of the substrate, and when the induced magnetic field generated by applying the first radio frequency source passes through the closed shielding ring, a reverse regenerated magnetic field is induced and is superposed on the induced magnetic field to adjust the magnetic field strength of the induced magnetic field.

10. The inductively-coupled plasma processing apparatus according to claim 9, wherein,
the shielding ring is in a closed loop structure surrounding edges of the first protrusion portion and the second protrusion portion of the magnetic field line adjusting component, and the shielding ring extends from the first protrusion portion to the second protrusion portion in longitudinal direction and is in tight connection with the first protrusion portion and the second protrusion portion, so that the shielding ring becomes a new sidewall of the reaction chamber.

11. The inductively-coupled plasma processing apparatus according to claim 10, wherein a second adjusting coil is wound around the shielding ring, and the second adjusting coil is applied with a fourth radio frequency source; by changing a power or frequency of the fourth radio frequency source, a second additional magnetic field is induced in the axial direction of the shielding ring, and the second additional magnetic field is superposed on the induced magnetic field to adjust magnetic field strength, shape and distribution of magnetic field lines at a edge portion of the substrate.

12. The inductively-coupled plasma processing apparatus according to claim 1, wherein a plurality of supply passages are arranged to pass through the magnetic field line adjusting component, and the supply passages comprise an electric passage through which the first radio frequency source is applied to the induction coil and an inlet passage through which the reaction gas is introduced into the reaction chamber.

13. A method for processing a substrate, comprising:
arranging, in an inductively-coupled plasma processing apparatus, a reaction chamber into which reaction gas is introduced, wherein the reaction chamber comprises a bottom base for fixing a substrate to be processed;
arranging an induction coil at periphery of the reaction chamber, wherein the induction coil is connected to a first radio frequency source to generate an induced electromagnetic field for producing plasma of the reaction gas in the reaction chamber to process the substrate;
arranging a magnetic field line adjusting component made of magnetic conductive material at the periphery of the reaction chamber, wherein the magnetic field line adjusting component has a reluctance smaller than that of air or vacuum, and constitutes a quasi-closed low reluctance path at the periphery of the reaction chamber, so that the magnetic field lines generated by the induction coil constitute a magnetic field line loop along the low reluctance path; and
adjusting reluctance distribution on the low reluctance path to adjust shape and distribution of the magnetic field lines in the magnetic field line loop that locate in the reaction chamber and thus control distribution of the plasma generated over a surface of the substrate under an action of the magnetic field lines.

14. The method for processing a substrate according to claim 13, wherein the magnetic field line adjusting component is made of magnetic conductive material having a magnetic permeability that is 10 or more times that of air magnetic permeability.

15. The method for processing a substrate according to claim 14, wherein the magnetic field line adjusting component is made of ferrite having a magnetic permeability that is 20-40 times that of air magnetic permeability.

16. The method for processing a substrate according to claim 13, wherein the magnetic field line adjusting component comprises a movable magnetic conductive component to adjust a shape and distribution of the magnetic field lines flowing through the magnetic field line adjusting componentor a magnetic field strength in the magnetic field line adjusting component by adjusting a position of the movable magnetic conductive component.

17. The method for processing a substrate according to claim 13, wherein:
the induction coil is arranged in a top portion or a bottom portion or on a sidewall of the reaction chamber; or the induction coil is arranged on the magnetic field line adjusting component such that any part of the low reluctance path on the magnetic field line adjusting component passes through the induction coil; and
the magnetic field strength in the magnetic field line adjusting component is controlled by a frequency or power of the first radio frequency source applied to the induction coil.

18. The method for processing a substrate according to claim 13, further comprising:
arranging a first adjusting coil such that any part of the low reluctance path on the magnetic field line adjusting component passes through the first induction coil; and
applying a third radio frequency source to the first adjusting coil, wherein by changing a power or frequency of the third radio frequency source, a first additional magnetic field is obtained in the magnetic field line adjusting component and is superposed on the induced magnetic field obtained by applying the first radio frequency source, thereby adjusting the magnetic field strength of the induced magnetic field.

19. The method for processing a substrate according to claim 13, further comprising:
arranging a shielding ring made of metallic conductor in the reaction chamber to surround an out edge of the substrate, selectively arranging a second adjusting coil on the shielding ring and applying a fourth radio frequency source, wherein by changing a frequency or power of the fourth radio frequency source, a second additional magnetic field is induced in the axial direction of the shielding ring and is superposed on the induced magnetic field to adjust a magnetic field strength and shape and distribution of the magnetic field lines at a edge portion of the substrate.

20. An inductively-coupled plasma processing apparatus, comprising:
a magnetic field line adjusting component made of magnetic conductive material, wherein the magnetic field line adjusting component comprises at least one quasi-closed loop with an open space, and the open space comprises a reaction chamber;
a reaction gas supply means and a substrate mounting platform in the reaction chamber; and
an induction coil connected to a radio frequency power supply, wherein magnetic field lines generated by the induction coil pass through the reaction chamber in the open space along the quasi-closed loop constituted by the magnetic field line adjusting component.
